(19) United States
(12) Patent Application Publication
(10) Pub. No.: US 2013/0124535 A1
(43) Pub. Date: May 16, 2013

(54) APPARATUS AND METHOD FOR CALCULATING INTIMACY

(71) Applicant: Electronics and Telecommunications Research In, Daejeon (KR)

(72) Inventors: Sung Kyong UN, Daejeon (KR); Do Won HONG, Daejeon (KR); Hyunsook CHO, Daejeon (KR); Youn-Hee GIL, Daejeon (KR); Keonwoo KIM, Daejeon (KR); Youngsoo KIM, Daejeon (KR); Sang Su LEE, Daejeon (KR); Jooyoung LEE, Daejeon (KR); Su Hyung JO, Daejeon (KR); Woo Yong CHOI, Daejeon (KR)

(73) Assignee: Electronics and Telecommunications Research Institute, Daejeon (KR)

(21) Appl. No.: 13/668,165

(22) Filed: Nov. 2, 2012

(30) Foreign Application Priority Data
Nov. 16, 2011 (KR) 10-2011-0119515

(51) Int. Cl. G06F 17/30

(52) U.S. Cl. 707/748; 707/E17.033

(57) ABSTRACT

An apparatus calculates an intimacy. The apparatus includes an information extraction unit to extract one of more communication logs to communicate with contact numbers in contact number information in a mobile terminal and a weight setting unit to set a weight on each communication log and each contact number. The apparatus further includes a time importance setting unit to set time importance in each communication log on the basis of service execution time of each communication log and an intimacy calculating unit to calculate an intimacy in each communication log on the basis of the time importance and the contact number with the weight, and calculate an intimacy between a user of the mobile terminal and each dialogist corresponding to the contact number using the intimacy in each communication log.

### RELATED APPLICATION(S)

This application claims the benefit of Korean Patent Application No. 10-2011-0119515, filed on Nov. 16, 2011, which is hereby incorporated by reference as if fully set forth herein.

### FIELD OF THE INVENTION

The present invention relates to intimacy calculation, and more particularly to an apparatus and method for calculating an intimacy with enhanced precision of calculating the intimacy between a user of a mobile terminal and a dialogist whom the user communicated with.

### BACKGROUND OF THE INVENTION

Mobile forensic is one of fields of digital forensics, whose main object is to extract and analyze communication logs in mobile terminals. The communication logs include a contact number (telephone number), time when a phone call was made, a transmission/reception list and contents of text messages, a photo, a video and the like. The analysis in the mobile forensic is to arrange contact number lists, to arrange phone calls and text message communication lists in an order of time, and to display photos and videos.

Compared with a mobile phone terminal whose main communication scheme is a phone call and text message exchange, smart phone to which data communication and computer capacity have been added has become very diversified as communication means. Setting E-mail, VoIP (Voice over Internet Protocol) and messenger aside, which were available in computers, social network service is also being used in the smart phone in a form of application.

In case of extracting communication logs utilizing each communication scheme and arranging them in a list in the smart phone, it is not easy to check the list at a look because of its large quantity compared with a mobile phone terminal. It is because frequency of use of the smart phone has been increased due to the number of added communication schemes and their conveniences.

Further, in case of displaying a list for each communication scheme separately, it is not easy to measure communication frequency for the same other party with whom communication was made using different communication scheme. Therefore, there is a difficulty in determining correlation between an event, which is important information obtainable using mobile forensic, and a communication dialogist related to the event.

### SUMMARY OF THE INVENTION

In view of the above, the present invention provides an apparatus and method for calculating an intimacy between a user of a mobile terminal and a dialogist using communication logs of the user as well as contact numbers in an address book of the mobile terminal.

The object of the present invention is not limited to the object described above and other objects that are not mentioned can be clearly understood when those skilled in the art read the following description.

In accordance with an aspect of the embodiment of the present invention, there is provided an apparatus for calculating an intimacy, the apparatus including: an information extraction unit configured to extract one of more communication logs to communicate with contact numbers in contact number information in a mobile terminal; a weight setting unit configured to set a weight on each communication log and each contact number; a time importance setting unit configured to set time importance in each communication log on the basis of service execution time of each communication log; and an intimacy calculating unit configured to calculate an intimacy in each communication log on the basis of the time importance and the contact number with the weight, and calculate an intimacy between a user of the mobile terminal and each dialogist corresponding to the contact number using the intimacy in each communication log.

In the apparatus, the communication log includes a phone call list, a message transmission/reception list, an E-mail transmission/reception list, a Twitter mention and direct message, a message on Facebook, a Chatting or an E-mail.

In the apparatus, the contact number information includes a phone number and name, an E-mail address, a Twitter ID or a Face book ID stored in the address book of the mobile terminal.

In the apparatus, the weight setting unit sets the weight in each communication log in consideration of the number of communication and communication time performed with each dialogist corresponding to the contact number.

In the apparatus, the intimacy calculating unit calculates the intimacy for each communication log by multiplying the weight and time importance given to each communication log.

In the apparatus, the intimacy calculating unit classifies intimacies for the communication log in each dialogist and then sums the intimacies for communication log in each dialogist to calculate the intimacy in each dialogist.

In accordance with another aspect of the embodiment of the present invention, there is provided a method for calculating an intimacy, the method including: extracting contact numbers of dialogists who communicated with a user of a mobile terminal using contact number information stored in the mobile terminal; extracting one or more communication logs to communicate with the user using the contact numbers information; setting a weight in each communication log and each contact number; setting time importance in each communication log on the basis of service execution time of each communication log; calculating an intimacy of each communication log on the basis of the time importance and the contact number with the weight; and calculating an intimacy between the user of the mobile terminal and each dialogist in the contact number information using the intimacy for each communication log.

In the method, the extracting one or more communication logs includes: extracting the communication logs on the basis of information on a phone call list, a message transmission/reception list, an E-mail transmission/reception list, a Twitter mention and direct message, a message on Facebook, a Chatting or an E-mail in the mobile terminal.

In the method, the extracting contact numbers of dialogists includes: extracting a phone number and name, an E-mail address, a Twitter ID or a Facebook ID stored in the address book of the mobile terminal; and extracting contact number information of the dialogist.

In the method, the setting a weight in each communication log and each contact number includes: setting a weight in each communication log in consideration of the number of communication and communication time performed with each dialogist corresponding to the contact number.

In the method, the calculating an intimacy of each communication log includes: multiplying the weight and time importance given to each communication log to calculate the intimacy for each communication log.

In the method, the calculating an intimacy between the user of the mobile terminal and each dialogist includes: classifying intimacies for the communication log in each dialogist; and summing the intimacies for communication log in each dialogist to calculate the intimacy in each dialogist.

### BRIEF DESCRIPTION OF THE DRAWINGS

The above and other objects and features of the present invention will become apparent from the following description of embodiments given in conjunction with the accompanying drawings, in which:

FIG. 1 illustrates a block diagram of an apparatus for calculating an intimacy with dialogist in accordance with an embodiment of the present invention; and

FIG. 2 is a flowchart illustrating a method for calculating an intimacy with dialogist in accordance with an embodiment of the present invention.

### DETAILED DESCRIPTION OF THE EMBODIMENTS

Hereinafter, an apparatus and method for calculating an intimacy with dialogist and method will be described with reference to the accompanying drawings, which calculate a dialogist intimacy based on weight according to importance, the number of communication and the newest of documents using communication logs.

Hereinafter, embodiments of the present invention will be described in detail with reference to the accompanying drawings so that they can be readily implemented by those skilled in the art.

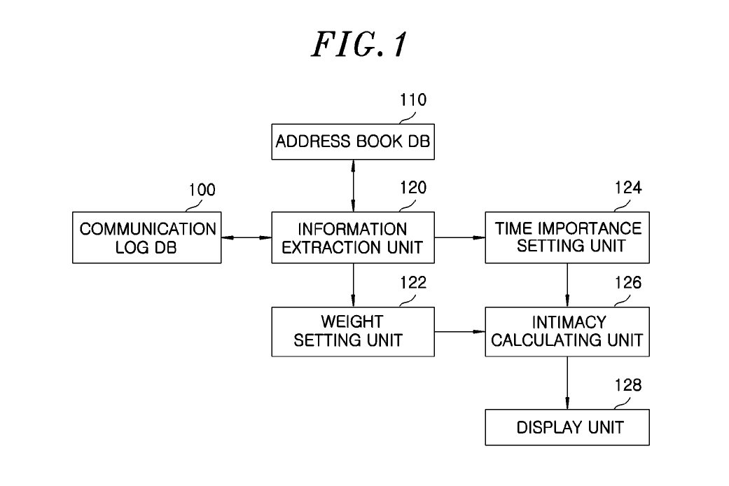

FIG. 1 illustrates a block diagram of an apparatus for calculating an intimacy in accordance with an embodiment of the present invention. The apparatus for calculating an intimacy may be embodied in a form of software programs installed or hardware components mounted in a mobile terminal. For example, the mobile terminal may cover wired and wireless communication devices such as a mobile phone, smart phone, Personal Digital Assistant (PDA), and the like having a communication capability.

The apparatus includes an address book database (DB) 110, a communication log DB 100, an information extraction unit 120, a weight setting unit 122, a time importance setting unit 124, and an intimacy calculating unit 126.

The information extraction unit 120 extracts one or more communication logs to communicate with contact number information stored in the address book DB 110 and communication logs DB 100.

In this regard, the contact number information may be an identifier to distinguish users (dialogists) in tools that can be used for communication, including a phone number and name, an E-mail address, a Twitter ID, and a Facebook ID of the users. Further, the tools may include software for phone call, software for message communication, software for E-mail communication, and software for Twitter, Facebook, and chatting, for example.

In addition, the communication logs may include all kinds of service records that can be used for communication, such as a phone call list, a short message or MMS (Multimedia Messaging Service) message transmission/reception list, an E-mail transmission/reception list, a Twitter mention or direct message, a message on Facebook, a Chatting, an E-mail.

The weight setting unit 122 sets weight on each communication log and each contact number in the contact information. More specifically, the weight setting unit 122 sets weight on each communication log in consideration of the fact that each communication log has its own importance. For example, it can be determined that a 10-minute call is more important than a call within 1 minute in the phone call so that a dialogist of 10-minute call has higher importance than a dialogist of 1 minute call, and therefore a higher weight may be set on the dialogist of 10-minute call. Further, it can be determined that conversing with the other party using E-mail is more important than sending a short message in consideration of consumed time to prepare E-mail and formality of record and that the communication with dialogist using E-mail has higher importance than that of short message. Therefore, a higher weight may be set on E-mail.

For the contact number, a dialogist given an abbreviated contact number has much higher importance than a dialogist having no abbreviated contact number, thereby giving a higher weight on the dialogist having abbreviated number.

An example to give the weight is described as Table 1 below.

TABLE 1

| CONTACT NUMBER/ | | |
|---|---|---|
| PHONE CALL LOG | WEIGHT | REMARKS |
| Other party on | 2ⁿ | ‘n’ denotes the number of |
| contact number | | contact means (phone |
| | | number, E-mail address, |
| | | service identifier, etc.) |
| Abbreviated | 10 | |
| number | | |
| Facebook friend | 5 | |
| phone call | 1*n | ‘n’ denotes phone call time |
| | | (min.) |
| Short message | 1 | |
| E-mail message | 5 | |
| Facebook | 3 | |
| message | | |
| Twitter mention | 0.25 | |
| Twitter direct | 1 | |
| message | | |

As described above, the weight setting unit 122 sets a weight on each communication log and each contact number in the contact number information on the basis of the Table 1. That is, the weight setting unit 122 sets weight in consideration of the time and number of communication.

The time importance setting unit 124 sets time importance for each communication log based on service execution time of each communication log. More specifically, a recent communication log has more important than a past communication log in the communication logs, and therefore the recent communication log has higher time importance than the past communication log. An example for this case is shown in Table 2 below.

TABLE 2

| SERVICE EXECUTION TIME | WEIGHT |
|---|---|
| Within 1 week | 1.0 |
| From 1 week to 1 month | 0.75 |
| From 1 to 3 months | 0.5 |
| From 3 months to 1 year | 0.25 |
| Over 1 year | 0.1 |
| Communication log having no | 1.0 |
| time, e.g., contact number | |

As described above, the time importance setting unit 124 sets time importance on each communication log using service execution time of each communication log based on the Table 2.

The intimacy calculating unit 126 calculates an intimacy in each communication log based on weight and time importance in each communication log, arranges the intimacy for each communication log in each dialogist, and calculates an intimacy for the communication log in each dialogist, thereby calculating the intimacy in each dialogist.

The intimacy for each communication log may be calculated by multiplying weight and time importance. Further, the intimacy in each dialogist means summation of intimacies for communication logs of each dialogist, which can be expressed as STⱼ in mathematical Equation 1 below.

$${ST}_{j} = {\sum }_{i = 1}^{n} ( {W}_{i} * {T}_{i} ) \qquad Eq . 1$$

In the mathematical equation 1, i denotes each record information corresponding to a specific dialogist j; Wᵢ denotes weight for i; and Tᵢ denotes time importance for i.

The display unit 128 displays intimacy between each dialogist and the user of a mobile terminal on a display device (not shown) such as a liquid crystal display (LCD).

As described above, it is easy to determine the important person among dialogists by calculating an intimacy between the user of the mobile terminal and the dialogist whom the user communicated with and displaying relationship between the user and the dialogist based on the intimacy.

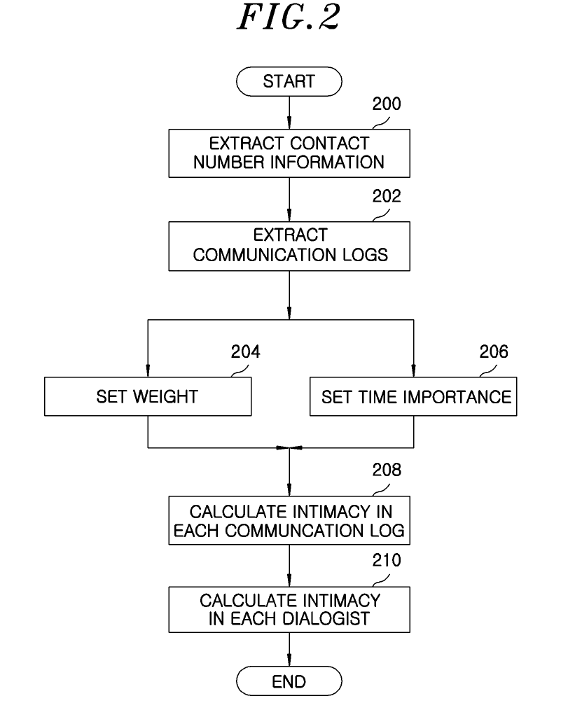

A procedure to calculate an intimacy between the user and dialogists using the apparatus for calculating an intimacy will be explained with reference to FIG. 2.

FIG. 2 is a flowchart illustrating a method for calculating an intimacy with dialogist in accordance with an embodiment of the present invention.

Referring to FIG. 2, the information extraction unit 120 extracts contact number information from the address book DB 110 in operation 200 and extracts one or more communication logs to communicate with the contact number from the communication log DB 100 in operation 202.

In this embodiment, the contact number information may be an identifier to distinguish the dialogist in tools that may be used for communication and may include a phone number and name stored in an address book of a mobile terminal, an E-mail address of the other party extracted from the communication log, a Twitter ID, and a Facebook ID of the other party. Further, the communication logs may include all kinds of service logs that may be used for such communication as a phone call list, a short message or MMS transmission/reception list, an E-mail transmission/reception list, a Twitter mention or direct message, a message on Facebook, a chatting and an E-mail.

The extracted contact number information and communication logs are provided to the weight setting unit 122 and time importance setting unit 124. The weight setting unit 122 sets weight on each communication log and each contact number on the basis of Table 1 in operation 204 and then provides an intimacy calculating unit 126 with the communication log and contact number with the weight.

Meanwhile, the time importance setting unit 124 sets time importance for each communication log based on service execution time of the communication log on the basis of Table 2 in operation 206. The time importance of each communication log set as such is provided to the intimacy calculating unit 126.

The intimacy calculating unit 126 calculates an intimacy for each communication log by calculating the weight and the time importance set in each communication log in operation 208.

Subsequently, the intimacy calculating unit 126 classifies the intimacies in each dialogist, and calculates an intimacy between each dialogist and the user based on the classified intimacies in operation 210. That is, the intimacy calculating unit 126 calculates intimacies between all dialogists and the user in a way to sum intimacies of the communication logs between an arbitrary dialogist and the user, thereby calculating an intimacy for the arbitrary dialogist.

The intimacy between each dialogist and the user calculated as such is then displayed on the display unit 128.

In accordance with the intimacy calculating method in accordance with an embodiment, it is possible to enhance precision of calculating an intimacy between dialogist and user and determine important persons among dialogists with ease, by calculating intimacies between a user of the mobile terminal and a dialogist whom the user communicated with on the basis of time importance and weight and then displaying relationship between the user and the dialogists based on the intimacy.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An apparatus for calculating an intimacy, the apparatus comprising:
an information extraction unit configured to extract one of more communication logs to communicate with contact numbers in contact number information in a mobile terminal;
a weight setting unit configured to set a weight on each communication log and each contact number;
a time importance setting unit configured to set time importance in each communication log on the basis of service execution time of each communication log; and
an intimacy calculating unit configured to calculate an intimacy in each communication log on the basis of the time importance and the contact number with the weight, and calculate an intimacy between a user of the mobile terminal and each dialogist corresponding to the contact number using the intimacy in each communication log.

2. The apparatus of claim 1, wherein the communication log comprises a phone call list, a message transmission/reception list, an E-mail transmission/reception list, a Twitter mention and direct message, a message on Facebook, a Chatting or an E-mail.

3. The apparatus of claim 1, wherein the contact number information comprises a phone number and name, an E-mail address, a Twitter ID or a Face book ID stored in the address book of the mobile terminal.

4. The apparatus of claim 1, wherein the weight setting unit sets the weight in each communication log in consideration of the number of communication and communication time performed with each dialogist corresponding to the contact number.

5. The apparatus of claim 1, wherein the intimacy calculating unit calculates the intimacy for each communication log by multiplying the weight and time importance given to each communication log.

6. The apparatus of claim 1, wherein the intimacy calculating unit calculates the intimacy in each dialogist by classifying intimacies for the communication log in each dialogist and then summing the intimacies for communication log in each dialogist.

7. A method for calculating an intimacy, the method comprising:
extracting contact numbers of dialogists who communicated with a user of a mobile terminal using contact number information stored in the mobile terminal;
extracting one or more communication logs to communicate with the user using the contact numbers information;
setting a weight in each communication log and each contact number;
setting time importance in each communication log on the basis of service execution time of each communication log;
calculating an intimacy of each communication log on the basis of the time importance and the contact number with the weight; and
calculating an intimacy between the user of the mobile terminal and each dialogist in the contact number information using the intimacy for each communication log.

8. The method of claim 7, wherein said extracting one or more communication logs comprises:
extracting the communication logs on the basis of information on a phone call list, a message transmission/reception list, an E-mail transmission/reception list, a Twitter mention and direct message, a message on Facebook, a Chatting or an E-mail in the mobile terminal.

9. The method of claim 7, wherein said extracting contact numbers of dialogists comprises:
extracting a phone number and name, an E-mail address, a Twitter ID or a Facebook ID stored in the address book of the mobile terminal; and
extracting contact number information of the dialogist.

10. The method of claim 7, wherein said setting a weight in each communication log and each contact number comprises:
setting a weight in each communication log in consideration of the number of communication and communication time performed with each dialogist corresponding to the contact number.

11. The method of claim 7, wherein said calculating an intimacy of each communication log comprises:
multiplying the weight and time importance given to each communication log to calculate the intimacy for each communication log.

12. The method of claim 7, wherein said calculating an intimacy between the user of the mobile terminal and each dialogist comprises:
classifying intimacies for the communication log in each dialogist; and
summing the intimacies for communication log in each dialogist to calculate the intimacy in each dialogist.
